(19) United States
(12) Patent Application Publication
(10) Pub. No.: US 2009/0313064 A1
(43) Pub. Date: Dec. 17, 2009

(54) DELIVERY MANAGEMENT SYSTEM

(76) Inventors: Yoshiaki Maeda, Tokyo (JP); Toshihiro Inomata, Tokyo (JP); Koichi Watanabe, Tokyo (JP); Kaori Mizuno, Tokyo (JP); Katsunori Nakai, Tokyo (JP); Kazunobu Miyazawa, Tokyo (JP); Yuka Homma, Tokyo (JP); Ken Okamoto, Tokyo (JP); Kenichi Ito, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 12/307,434

(22) PCT Filed: Jul. 4, 2007
(86) PCT No.: PCT/JP2007/063394

§ 371 Date: Jun. 18, 2009

(30) Foreign Application Priority Data
Jul. 5, 2006 (JP) 2006-185803

(51) Int. Cl. G06Q 10/00; G06Q 30/00; G06Q 50/00

(52) U.S. Cl. 705/7; 705/28; 705/26

(57) ABSTRACT

An item delivery service capable of distributing items while maintaining anonymity between an exhibitor (vendor) and a successful bidder (purchaser) is provided.

According to a delivery management system (when used for an escrow system) of the present invention, an exhibitor terminal 240 is notified only of information about a delivery service base in charge of an address of a successful bidder for delivery of an item. Accordingly, the item can be delivered up to the delivery service base even when the exhibitor does not know personal information such as the address and name of the successful bidder.

On the other hand, a service base terminal 232 of the delivery service base where the item arrives is notified of personal information of the successful bidder. Accordingly, the item can be delivered from the delivery service base to the successful bidder even if personal information of the exhibitor is not described on a delivery form or the like of the item (without notifying the successful bidder of personal information of the exhibitor). That is, according to the present invention, items can be distributed while maintaining anonymity between the exhibitor and the successful bidder.

### TECHNICAL FIELD

The present invention is an invention relating to a system for providing a distribution service while maintaining anonymity between a vendor and a purchaser.

### BACKGROUND ART

Here, description is made by taking an example in which a conventional distribution service (delivery service) is used for an escrow service.

The escrow service is a service in which the exchange of items and payment between a vendor and a purchaser is mediated by a third party (escrow service providing company). The escrow service is particularly used for auctions on the Internet (herein after, referred to as net auctions) in which most transactions are conducted between individuals.

<Overview of a Conventional Escrow Service>

FIG. 1 shows an example of mechanism (flow of an item and payment) in a conventional escrow service. Here, the conventional escrow service is described by taking an example in which the escrow service is used for net auctions. Only the flow after a successful bid of an auction item will be described and the flow from an item being put up to a successful bid of the item is not described here.

An auction company 110 is an operator of net auction and ties up with an escrow service providing company 120 (for example, a financial institution), which is a provider of escrow service, so that a user can use the escrow service in a net auction.

Users 140 and 150 are registered with the auction company 110 and are users who can participate in net auctions. Here, the user 140 is described as an exhibitor of an item and the user 150 as a successful bidder.

A delivery company 130 is a delivery undertaker providing a delivery service (such as a postal service and home delivery service) and accepts an auction item from the exhibitor 140 to deliver the auction item to the successful bidder 150. The delivery company 130 has a service base in each region taking charge of collection and delivery in the region. Hereinafter, a service base (a service base 132) where an item is accepted from the exhibitor 140 is referred to as an acceptance service base (including transit bases, which also applies below) and a service base (a service base 134) where an item is delivered to the successful bidder 150 is referred to as a delivery service base (including transit bases, which also applies below). Each service base serves as both the acceptance service base and delivery service base or only either of the acceptance service base or the delivery service base. The delivery company may provide an escrow service (when the delivery company 130 and the escrow service providing company 120 are the same company).

It is assumed, as described above, that a successful bid of an auction item is made and the successful bidder 150 is notified of the price to be paid (for example, the total of a contract price and a fee). Hereinafter, the flow of payment and item will be described according to numbers in parentheses in FIG. 1.

(1) Payment

First, the successful bidder 150 deposits a payment in the escrow service providing company 120. More specifically, for example, the payment is deposited into an account specified by the escrow service providing company 120 or paid by credit card.

(2) Notification of Receipt of Payment

The escrow service providing company 120 notifies the exhibitor 140 that the payment has been received. A notification of receipt of payment may be made via the auction company 110. That is, the auction company 110 is first notified from the escrow service providing company 120 (2′-1) and then, the exhibitor 140 is notified from the auction company 110 (2′-2).

(3) Item Carrying-In

After being notified of receipt of payment, the exhibitor 140 carries in an item to the acceptance service base 132 (for example, the nearest service base from home) of the delivery company 130 to ask the delivery of the item to the successful bidder 150.

At this point, the exhibitor 140 fills necessary information in a delivery request form. Normally, the address, name and the like of the exhibitor 140 are entered in a requester field and the address, name and the like of the successful bidder 150 are entered in a receiver field. That is, it is necessary to notify the exhibitor of the address, name and the like of the successful bidder in advance to deliver the item to the successful bidder 150 and this can be done by communication between the exhibitor and successful bidder by e-mails, etc., or a notification or the like from the auction company 110.

(4) Delivery from the Acceptance Service Base to the Delivery Service Base

The item carried in to the acceptance service base 132 is delivered to the delivery service base 134 in charge of collection and delivery of the region in which the address of the successful bidder 150 is located according to delivery routes set up in the delivery company 130.

(5) Item Delivery

The item is delivered from the delivery service base 134 to the address of the successful bidder 150.

(6) Notification of Receipt

The successful bidder 150 notifies the escrow service providing company 120 that the item has been received. If the item is damaged or the like, the payment can be refunded from the escrow service providing company 120 by notifying the escrow service providing company 120 of such damage and canceling the transaction.

A notification of receipt can also be made, in a similar manner as (2) notification of receipt of payment described above, via the auction company 110. In this case, the auction company 110 is first notified from the successful bidder 150 (6′-1) and then, the escrow service providing company 120 is notified from the auction company 110 (6′-2).

(7) Remittance

After receiving the notification of receipt from the successful bidder 150, the escrow service providing company 120 remits the payment to the exhibitor 140.

<System Configuration Example of a Conventional Escrow Service>

The escrow service described in FIG. 1 can be realized, for example, by a system configuration shown in FIG. 2. Here, an example in which the escrow service providing company 120 is a financial institution such as a bank and the successful bidder 150 transfers the payment for an item to an account managed by the financial institution is taken, but the escrow service providing company 120 may be another company having an account opened with a financial institution. In addition to the transfer of payment to a financial institution such as a bank, other payment methods such as payment by credit card may also be used.

Similarly to FIG. 1, only a part concerning the escrow service after a successful bid of an item will be illustrated and described. A conventional normal auction system can be used for processes from an exhibition of an item to a successful bid (an exhibition, bidding, a successful bid and the like).

In FIG. 2, an auction company server 210 is a server for providing a net auction service by the auction company 110. A financial institution server 220 is a server for providing an escrow service by the escrow service providing company 120 (here, a financial institution such as a bank).

A delivery company server 230 is a server for providing a delivery service by the delivery company 130. A service base terminal 232 is a terminal such as a personal computer that is installed at each service base of the delivery company 130 and can communicate with the delivery company server 230 and is used for delivery operations and the like by persons in charge (staff members or the like) at each service base.

A user (exhibitor) terminal 240 and a user (successful bidder) terminal 250 are terminals such as personal computers, mobile phones or the like used by exhibitor 140 and the successful bidder 150, respectively.

Networks 260 and 262 are communication networks such as the Internet, dedicated lines, or intranets.

For example, an escrow management account 224 is provided on the financial institution server 220 for receipt of payment and remittance. The escrow service providing company 120 (financial institution) temporarily receives the payment for an item paid by the successful bidder 150 ((1) in FIG. 1) in an account provided by the escrow management account 224 and, after a notification of receipt being received from the successful bidder 150 ((6) in FIG. 1), remits the payment to an account of the exhibitor 140 opened with the escrow management account 224 ((7) in FIG. 1).

The financial institution server 220 transmits a notification of receipt of payment to the exhibitor terminal 240 ((2) or (2′-1) in FIG. 1) and receives a notification of receipt from the successful bidder terminal 250 ((6) or (6′-2) in FIG. 1) by means of e-mails or the like via the auction company server 210 through the communication network 262 such as a dedicated line.

An escrow management system 222 is a computer system that performs processing such as receipt of payment and remittance, transmits a notification of receipt of payment, and receives a notification of receipt.

The mechanism inside the financial institution server 220 shown in FIG. 2 is only an example and the mechanism only needs to be able to perform processing on the payment side of a conventional escrow service described with reference to FIG. 1.

In a delivery company server 230, a delivery information database 238 in which, for example, the collection and delivery region taken charge of by each service base and delivery information are stored is provided. Accordingly, a delivery route for delivering an item to the successful bidder 150 and a service base to be the delivery service base 134 can be decided in the delivery server 230 to make a notification to the service base terminal 232 of the acceptance service base 132.

A delivery system 236 is a computer system that performs processing such as the delivery route decision and the notification to the service base terminal 232 described above.

The mechanism inside the delivery company server 230 shown in FIG. 2 is only an example and the mechanism only needs to be able to perform processing on the item side of a conventional escrow service described with reference to FIG. 1. That is, any mechanism that can provide a conventional normal delivery service may be used.

An auction system 212 in the auction company server 210 is a computer system that performs each processing of a net auction. When a notification of receipt of payment and that of receipt shown in FIG. 1 are made via the auction company 110 in an escrow service after a successful bid of item, a notification of receipt of payment is received from the financial institution server 220 ((2′-1) in FIG. 1) and a notification of receipt is transmitted to the financial institution server 220 ((6′-2) in FIG. 1) via the communication network 262 and the notification of receipt of payment is transmitted to the exhibitor terminal 240 ((2′-2) in FIG. 1) and the notification of receipt is received from the successful bidder terminal 250 ((6′-1) in FIG. 1) via the communication network 260.

Also, a user database 214 and an auction database 216 are provided in the auction company server 210 so that the auction system 212 can perform each processing of a net auction.

The user database 214 is a database that stores information about users registered with the auction company 110. FIG. 3A shows, among items of the user database 214, items necessary for describing the escrow service. “User ID” is an ID unique to each user and “Password” is a password of a user. A user can participate (exhibition and bidding) in a net auction by logging in to the auction system 212 by means of the user ID and password.

“Name” is the name of a user. “Address” is the address of a user and is stored, for example, as shown in FIG. 3A, by itemizing the address such as “Zip code”, “Prefecture”, “City”, “Block”, “House number”, “Others” (building name, room number, etc.) and the like in the order in which the items appears in a Japanese address. The itemization is only an example and other itemizations are possible or the address need not be necessarily divided. “E-mail address” is an e-mail address of a user and can be used, for example, for a notification from the auction company server 210 to the user terminal (here, the exhibitor terminal 240 or the successful bidder terminal 250) or the like.

Registering personal information of users in the user database 214 of the auction company 110 in this manner is helpful in preventing troubles and improving reassurance and reliability of transactions to users.

The auction database 216 is a database that stores information about auctions (such as item information and information about exhibition, bidding, and successful bids). FIG. 3(b) shows, among items of the auction database 216, items necessary for describing the escrow service. “Auction ID” is an ID unique to each auction. “Exhibitor user ID” and “Successful bidder user ID” are user IDs of the user (exhibitor) 140 and the user (successful bidder) 150, respectively. “Item information” is an item name registered when the user (exhibitor) 140 exhibits an item or a description of an item, and “Payment information” is information about the price (a contract price, a fee, etc.) to be paid by the successful bidder.

The auction system 212 references and updates the user database 214 and the auction database 216 between exhibition and successful bid of an item of auction to display progress or results of auction in the net auction Web page or to notify users (an exhibitor, bidders, a successful bidder and the like) of progress or results of auction through e-mails or the Web page.

<Advantages and Disadvantages of the Conventional Escrow Service>

By using the conventional escrow service shown in FIG. 1 and FIG. 2, an exhibitor (vendor) can send an item after making sure that a payment can be received and a successful bidder (purchaser) can make payment to the exhibitor after the item has arrived. Thus, the escrow service is helpful in preventing troubles such as “The item does not arrive though I have made the payment.” or “The payment is not made though I have sent the item.”, which are problems of conventional net auctions.

However, as described above, in sending an item from an exhibitor (vendor) to a successful bidder (purchaser) using a conventional delivery service of a delivery company, it is necessary to fill personal information such as the names and addresses of both the requester (exhibitor) and receiver (successful bidder) in a delivery request form.

That is, the exhibitor needs personal information of the successful bidder to send an item and, on the other hand, the successful bidder can know personal information of the exhibitor by reading the form affixed to the received item.

Thus, when the conventional delivery service is used, personal information is mutually known between the exhibitor and successful bidder.

Regarding the flow of payment, the successful bidder (purchaser) makes payment to a specified account of the escrow service providing company and then, the escrow service providing company makes payment to the exhibitor (vendor) and thus, the payment can anonymously be made between the exhibitor (vendor) and successful bidder (purchaser).

It is highly necessary to register personal information of users in an auction system for the purpose of preventing troubles, improving confidence in transactions and so on. However, in current net auctions, exhibitors and bidders often make a decision about the other party by checking a transaction history (assessments, the number of transactions and the like) released on an auction system and necessity to let even personal information such as the name and address be known is considered to be low. Or rather, the danger of leakage of personal information through transactions has become a problem and thus, there is a strong desire for anonymity particularly in net auctions in which transactions between individuals are frequently conducted.

### DISCLOSURE OF THE INVENTION

### Problem to be Solved by the Invention

An object of the present invention is to solve the above problem by providing a service for delivering an item while maintaining anonymity between an exhibitor (vendor) and a successful bidder (purchaser).

### Means for Solving the Problem

In order to solve the above problem, one aspect of the invention relates to a delivery management system for delivering an item from a vendor to a purchaser, comprising:

a server connected to a terminal of the vendor and a terminal of each service base which collects/delivers the item,

the server comprising:

user storage means for storing address and name information of the vendor and the purchaser;

transaction storage means for storing the vendor and the purchaser in association with each other based on each transaction ID of transaction of the item;

service base storage means for storing location information of the service base and collection/delivery service area information taken charge of by the service base in association with each other;

form number registration means for, when a form number of the item is input from the terminal of the vendor, storing the form number in the transaction storage means in association with the transaction ID;

delivery service base information notification means for searching for a service base whose collection/delivery service area includes the address of the purchaser stored in the user storage means and transmitting the location information of the service base to the terminal of the vendor; and

purchaser information notification means for, when an inquiry based on the form number is received from the terminal of the service base, searching the form number registration means for a transaction ID related to the form number, searching the transaction storage means for a purchaser related to the transaction ID, and transmitting the address and name of the purchaser to the terminal of the service base.

In the invention, it is possible that the location information stored in the service base storage means includes a zip code, and

the delivery service base information notification means transmits the zip code of the selected service base to the terminal of the vendor.

Further, in the invention, it is possible that the address information stored in the user storage means includes a zip code,

the service base storage means stores the collection/delivery service area information as the zip code, and

the delivery service base information notification means selects the service base of the collection/delivery service area corresponding to the zip code of the purchaser.

Further, the invention may comprises:

form number generation means for generating a form number corresponding to each transaction,

wherein the form number registration means stores the generated form number in the service base storage means in association with the transaction ID, and

the delivery service base information notification means generates electronic data of the delivery form having the form number and the location information of the selected service base and transmits the electronic data to the terminal of the vendor.

Further, in the invention, it is possible that the delivery service base information notification means transmits the transaction ID to the terminal of the vendor together with the location information of the service base or instead of the location information of the service base.

Further, in the invention, it is possible that when the form number or transaction ID transmitted from the terminal of the service base at the service base to which the item with the delivery form affixed thereto is delivered is received, the purchaser information notification means transmits the address and name of the associated purchaser from the user storage means to the terminal of the service base.

Further, in the invention, it is possible that the service base storage means further stores a service base ID of the service base, and

when the form number or transaction ID is received from the terminal of the service base, the purchaser information notification means searches the service base storage means for the transmitted service base ID of the service base and, if the service base ID and a service base ID identifying the service base selected by the delivery service base information notification means match each other, transmits the address and name of the purchaser associated with the form number or transaction ID from the user storage means to the terminal of the service base.

An other aspect of the invention relates to a delivery management system for delivering an item from a sender to a receiver, comprising:

a server connected to a terminal of the sender and a terminal of each service base which collects/delivers the item,

the server comprising:

delivery information storage means for storing information identifying each of the sender and the receiver and item identification information identifying the item in association with each other;

service area storage means for storing location information of the service base so that the service base in charge of collection/delivery from/to a collection/delivery destination of the item can be identified;

service base information notification means for, when the item identification information is input from the terminal of the sender, searching the delivery information storage means for information about the receiver associated with the item identification information, further searching the service area storage means for information about the service base in charge of collection/delivery from/to the receiver, and transmitting the information about the service base to the terminal of the sender; and

receiver information notification means for, when the identification information about the item delivered based on the service base information obtained by the service base information notification means as a destination is input from the terminal of the service base, searching the delivery information storage means for receiver information of the item, and transmitting the receiver information to the terminal of the service base.

Further, the invention may comprises:

delivery completion confirmation means for checking at the service base whether or not delivery is completed by setting the receiver information obtained by the receiver information notification means as a new delivery destination of the item.

Further, in the invention, it is possible that the receiver information notification means identifies from which service base input from the terminal of the service base comes and searches the service area storage means for the service base to take charge of collection/delivery when the receiver is set as a delivery destination and, if the two service bases do not match each other, searches the service area storage means for information about the collection/delivery service area, and transmits, instead of the receiver information, the information about the collection/delivery service area to the terminal of the service base.

Further, in the invention, it is possible that the information to identify the sender and the receiver includes at least a name and an address,

the item identification information includes at least one of a form number related to delivery of the item and a transaction ID related to a transaction of the item, and

the information related to the service base includes at least one of a name, a location, or a zip code of the service base.

Yet another aspect of the invention relates to a delivery management method for delivering an item from a vendor to a purchaser,

wherein address and name information of the vendor and the purchaser is stored in user storage means,

the vendor and the purchaser are stored in transaction storage means in association with each other based on each transaction ID of transaction of the item, and

location information of the service base and collection/delivery service area information taken charge of by the service base are stored in service base storage means in association with each other,

the method comprising:

a form number registration step of, when a form number of the item is input from the terminal of the vendor, storing the form number in the transaction storage means in association with the transaction ID;

a delivery service base information notification step of searching for the service base whose collection/delivery service area includes the address of the purchaser stored by the user storage means, and transmitting the location information of the service base to the terminal of the vendor; and

a purchaser information notification step of, when an inquiry based on the form number is received from the terminal of the service base, searching the form number registration means for the transaction ID associated with the form number, searching the transaction storage means for the purchaser associated with the transaction ID, and transmitting the address and name of the purchaser to the terminal of the service base.

Still another aspect of the invention relates to a delivery management method for delivering an item from a sender to a receiver,

wherein information identifying each of the sender and the receiver and item identification information identifying the item are stored in delivery information storage means in association with each other, and

location information of the service base is stored in service area storage means so that the service base in charge of collection/delivery from/to a collection/delivery destination of the item can be identified,

the method comprising:

a service base information notification step of, when the item identification information is input from the terminal of the sender, searching the delivery information storage means for information about the receiver associated with the item identification information, further searching the service area storage means for information about the service base in charge of collection/delivery from/to the receiver, and transmitting the information about the service base to the terminal of the sender; and

a receiver information notification step of, when the identification information about the item delivered based on the service base information obtained at the service base information notification step as a destination is input from the terminal of the service base, searching the delivery information storage means for the receiver information of the item, and transmitting the receiver information to the terminal of the service base.

Still another aspect of the invention relates to a program for causing a computer to realize each means of the delivery management system according to any one of the above inventions as a function.

### EFFECT OF THE INVENTION

When a delivery management system having a high level of anonymity according to the present invention is used for an escrow system, an auction company notifies an exhibitor only of information about a delivery service base (which is in charge of delivery to the address of a successful bidder and includes transit service bases) for delivery of an auction (transaction) item. On the other hand, the exhibitor notifies the auction company of the form number of a delivery form affixed to the item.

The exhibitor enters delivery service base information in the receiver field of the delivery form and carries in the item to an acceptance service base (to which the exhibitor carries in the item). Personal information of the exhibitor may be entered in the requester field. Accordingly, the item can be sent to the delivery service base even when the exhibitor does not know personal information such as the address, name and the like of the successful bidder. A delivery form on which the form number and necessary information are described may be prepared by the auction company and sent to the exhibitor.

On the other hand, the delivery service base at which the item arrives, on the other hand, makes an inquiry by informing the auction company of the form number of the delivery form. In response to the inquiry, the auction company notifies the delivery service base of information necessary for delivery to the successful bidder. Based on the information, the delivery service base prepares a new form by entering information necessary for delivery to the successful bidder in the receiver field and deleting information of the exhibitor that is not necessary for delivery from the requester field and replaces the form affixed to the item with the new form. Accordingly, the item can be delivered from the delivery service base to the successful bidder even without personal information of the exhibitor being entered in the delivery form (without the successful bidder being informed of personal information of the exhibitor).

Therefore, the successful bidder can receive the item without letting the exhibitor know personal information such as his (her) address, name and the like and the exhibitor can deliver the item without personal information of the exhibitor being known to the successful bidder. That is, according to a delivery management system of the present invention, items can be distributed while maintaining anonymity between exhibitors (vendors) and successful bidders (purchasers).

In addition, since transactions can be conducted without knowing personal information of other users, a burden of personal information protection of other users imposed on users in net auctions can be reduced.

A system in which an auction company also notifies an exhibitor of an auction ID (transaction ID) to make the exhibitor enter the auction ID in a form and a delivery service base makes an inquiry about personal information of a successful bidder by informing the auction company of the auction ID may also be adopted.

It is needless to say that a delivery management system of the present invention is not limited to being used for an escrow system. For example, an advantage similar to that of an escrow system can be achieved by a delivery company server having a device in which information for identifying each of a sender (an exhibitor in an escrow system) and a receiver (a successful bidder in an escrow system) and item identification information for identifying an item to be delivered are stored in association with each other. That is, the sender obtains delivery base information by notifying a delivery company of information identifying an item (for example, the transaction ID or delivery form number), enters the information in the receiver field of a delivery form and carries in the item to an acceptance service base. Similarly to a case of being used for an escrow system, the delivery company delivers the item to the delivery service base based on the information on the delivery form, replaces the form with a new one based on the form number of the delivery form at the delivery service based where the item has arrived, and delivers the item to a purchaser.

### BRIEF DESCRIPTION OF THE DRAWINGS

FIG. 1 is a diagram showing an example of a mechanism (a flow of an item and payment) of a conventional escrow service.

FIG. 2 is a diagram showing an example of a system configuration realizing the conventional escrow service.

FIG. 3A is a diagram showing main items of a user database and FIG. 3B is a diagram showing main items of an auction database.

FIG. 4 is a diagram showing an example of the flow of an item and payment of an escrow service using a delivery management service.

FIG. 5A is a diagram showing an example of a delivery form prepared by an exhibitor and FIG. 5B is a diagram showing an example of a delivery form prepared at a delivery service base.

FIG. 6 is a diagram showing an example of a system configuration realizing item delivery when the delivery management system is used for the escrow service.

FIG. 7A is a diagram showing main items of an auction database. FIG. 7B is a diagram showing main items of a service base database in the delivery management system.

FIG. 8 is a flow chart showing the flow of delivery service base information notification processing when the delivery management system is used for an escrow system.

FIG. 9 is a flow chart showing the flow of successful bidder information notification processing when the delivery management system is used for the escrow system.

FIG. 10A shows an example of a form number input page, FIG. 10B shows an example of a delivery service base information viewing page, and FIG. 10C shows an example of a confirmation page.

FIG. 11 is a diagram showing an example of the flow of item delivery when the delivery management system is used for delivery other than the escrow system.

FIG. 12 is a diagram showing an example of the system configuration realizing item delivery when the delivery management system is used for delivery other than the escrow system.

FIG. 13A is a diagram showing main items of a delivery information database and FIG. 13B is a diagram showing main items of a service area database.

FIG. 14 is a flow chart showing the flow of notification of delivery service base information to a sender when the delivery management system is used for a delivery system other than the escrow system.

FIG. 15 is a flow chart showing the flow of notification of receiver information to the delivery service base and registration of notification status with a delivery company server when the delivery management system is used for the delivery system other than the escrow system.

FIG. 16 is a flow chart showing the flow of detection of delivery to an inappropriate delivery service base and transfer to an appropriate delivery service base when the delivery management system is used for the delivery system other than the escrow system.

### DESCRIPTION OF REFERENCE NUMERALS

110 Auction company
120 Escrow service providing company
130 Delivery company
132 Service base (acceptance service base)
134 Service base (delivery service base)
140 User (exhibitor)
150 User (successful bidder)
210 Auction company server
212 Auction system
214 User database
216 Auction database
217 Delivery management system
218 Service base database
220 Financial institution server
222 Escrow management system
224 Escrow management account
230 Delivery company server
232 Service base terminal
236 Delivery system
238 Delivery information database
240 User (exhibitor) terminal
250 User (successful bidder) terminal
260, 262, 264 Communication network
330 Delivery company
332 Acceptance service base
334 Delivery service base
340 Sender
350 Receiver
430 Delivery company server
432 Delivery service base terminal
436 Delivery information database
438 Service area database
440 Sender terminal
460, 464 Communication network
1010 Form number input page
1012 Form number input field
1014 “Next” button
1020 Delivery service base information viewing page
1022 Receiver display field
1024 Requestor display field
1026 “Next” button
1030 Confirmation page
1032 Form number display field
1034 Receiver display field
1036 Requestor display field
1038 Link to item page

### PREFERRED EMBODIMENT FOR CARRYING OUT THE INVENTION

An embodiment of a delivery management system according to the present invention will be described below with reference to the drawings. Here, an example in which a delivery management system according to the present embodiment is used for an escrow system will be described.

<Overview of an Escrow Service Using a Delivery Management System of the Present Embodiment>

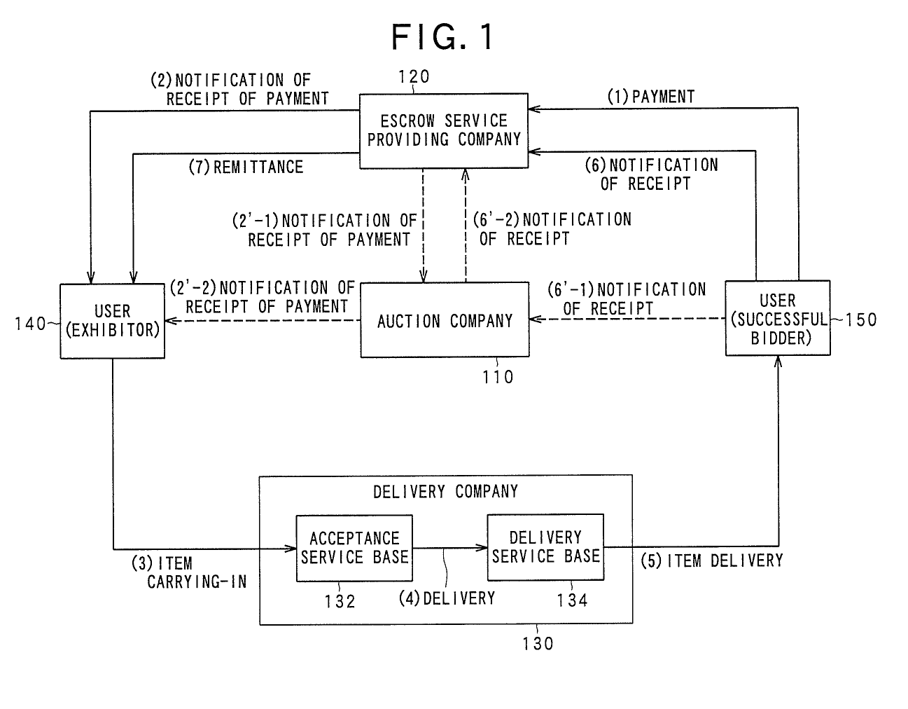

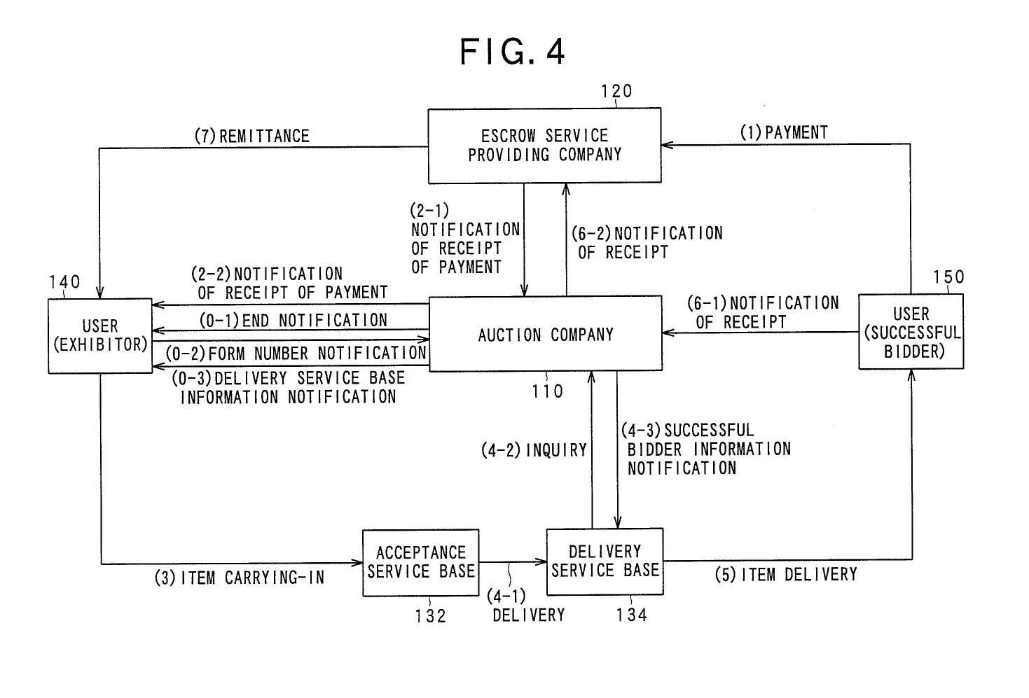

FIG. 4 shows an example of the flow of an item and payment of an escrow service when a delivery management system of the present embodiment is used for an escrow service of a conventional net auction. Reference numerals in FIG. 4 correspond to those in FIG. 1. Also here, only the flow after a successful bid of an item will be described. A conventional auction system can be used for processing from an exhibition of an item to a successful bid (an exhibition, bidding, a successful bid and the like).

The auction company 110, the service providing company 120, the user (exhibitor) 140, and the user (successful bidder) 150 are the same as those in a conventional escrow service shown in FIG. 1. The flow of payment ((1) Payment and (7) Remittance) is also the same as in the conventional escrow service. The notifications of (2) Notification of receipt of payment and (6) Notification of receipt are also the same as the conventional escrow service, and an example in which notifications are made via the auction company 110 is taken in FIG. 4.

On the other hand, in order to conduct distribution while maintaining anonymity between exhibitors (vendors) and successful bidders (purchasers), the delivery management system of the present embodiment is provided with a new mechanism for the flow of items. The new mechanism will be described below.

(0-1) Auction End Notification

When an auction ends, the auction company 110 notifies the exhibitor 140 that the auction has ended, for example, by e-mail. While it is also common in a conventional auction system to notify of the user ID and e-mail address of a successful bidder, a contract price and the like when an auction ends, in the present embodiment, a URL to a Web page in which the exhibitor enters the form number on a delivery form of an item or obtains information about the delivery service base (which is a service base in charge of collection/delivery from/to the address of a successful bidder and includes transit service bases) is further notified.

(0-2) Form Number Notification

The exhibitor 140 prepares a delivery form to be affixed to an item and notifies the auction company of the form number printed on the delivery form. Normally, a delivery form exclusive for the delivery company 130 is used. The auction company registers the form number in association with an auction (transaction).

(0-3) Notification of Delivery Service Base Information

Next, the auction company 110 notifies the exhibitor 140 of delivery service base information. That is, the auction company 110 decides the service base to be the delivery service base 134 corresponding to the successful bidder 150 and notifies the exhibitor 140 of the location of the delivery service base 134 as the delivery service base information. In addition to the location, the name of the delivery service base and the like may be notified.

In the present embodiment, it is assumed that the zip code of the delivery service base 134 is notified as the delivery service base information. This is particularly useful, for example, when the delivery company 130 is Japan Post. Also for the exhibitor 140 who receives the notification, the amount of information (7-digit zip code) is small and thus, the burden is light. If a home delivery service company other than Japan Post is the delivery company 130 and can deliver items from the acceptance service base 132 to the delivery service base 134 using the zip code, the zip code can be used as the delivery service base information in the same manner. If a delivery company cannot deliver items using the zip code, the exhibitor 140 may be notified of the location of the delivery service base.

Thus, the exhibitor 140 is notified of only delivery service base information. There is no need for the exhibitor 140 to know personal information such as the address and name of the successful bidder 150.

By making arrangements so that the auction company notifies the exhibitor 140 of the delivery service base information after the exhibitor 140 notifies the auction company of the form number, an input omission of the form number necessary for subsequent processing can be prevented.

Here, the delivery service base information is notified by a Web page that can be viewed only by exhibitors by login or the like, but the delivery service base information may be notified by an e-mail or a plurality of these methods may be used for notification. The exhibitor 140 is notified of the delivery service base information after the form number being notified from the exhibitor 140, but the order is not limited to this.

(3) Item Carrying-In

Similarly to the conventional escrow service described with reference to FIG. 1, the exhibitor 140 who has received a notification of receipt of payment carries in an item to the service base (the acceptance service base 132) of the delivery company 130 to request delivery of the item to the successful bidder 150. At this point, the delivery service base information (such as the location of the delivery service base 134: the zip code of the delivery service base 134 and the prefecture of the delivery destination in the present embodiment) notified at (0-3) is described in a delivery request form.

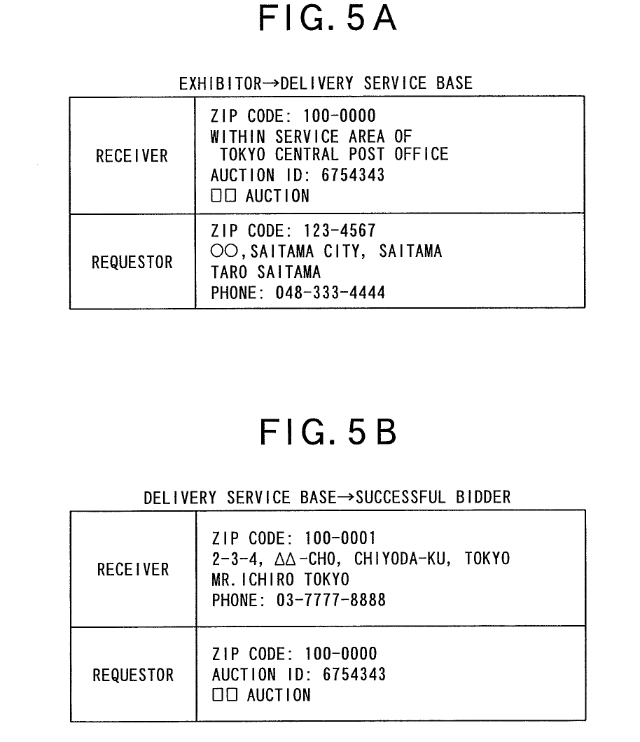

FIG. 5A shows an example of a filled-out delivery form. The delivery service base information (the zip code of the delivery service base 134) notified at (0-3) is entered in a “Receiver” field. Here, the auction ID and the prefecture of the delivery destination may be entered as well for convenience of confirmation. As shown in FIG. 5(a), in addition to the zip code of the delivery service base 134, the name of the delivery service base 134 may also be entered. The exhibitor 140 may be notified of the name of the delivery service base together with the delivery service base information (zip code) at (0-3) as described above or the name of the delivery service base 134 may be entered by the exhibitor 140 or a person in charge at the acceptance service base 132 by finding the name of the service base 134 corresponding to the zip code at the acceptance service base 132.

Further, the auction name or auction company name (here, “□□ auction”) may also be entered in the “Receiver” field. Accordingly, a person in charge (such as a staff member) at the delivery service base 134 that received the item can know that the package is based on the escrow service using a delivery management system of the present embodiment and requires an inquiry at the auction company 110 about information on the successful bidder 150.

In a “Requestor” field, similarly to a conventional delivery form, information such as the address, name, phone number and the like of the exhibitor 140 is entered. By entering information about the exhibitor in this manner, an inquiry at the exhibitor 140 can be made or the item can be sent back from the acceptance service base 132 or the delivery service base 134 if there is any unclear point, similarly to a conventional delivery service.

Further, the user ID of the successful bidder 150 may be entered in the “Receiver” field and that of the exhibitor 140 in the “Requestor” field. By entering the user IDs, confirmation can be requested if the exhibitor 140 should enter a wrong auction ID or the like.

With the delivery form shown in FIG. 5A, the item can be delivered to the delivery service base 134 without personal information of the successful bidder 150 such as the address and name.

(4-1) Delivery from the Acceptance Service Base to the Delivery Service Base

The item to which the delivery form shown in FIG. 5A is affixed is delivered to the delivery service base 134 according to a conventional delivery route of the delivery company 130.

(4-2) Inquiry at the Auction Company from the Delivery Service Base

The delivery service base 134 that received the item makes an inquiry at the auction company 110 using the form number of the delivery form in FIG. 5A affixed to the item.

(4-3) Notification of Successful Bidder Information from the Auction Company to the Delivery Service Base

In response to the inquiry, the auction company 110 notifies the delivery service base 134 of information including the address and name of the successful bidder 150 of the auction corresponding to the form number that is necessary to deliver the item to the successful bidder 150 as successful bidder information. Thus, the delivery service base 134 is notified only of information about the successful bidder 150.

At the delivery service base 134, a new delivery form is prepared by entering information on the successful bidder in the receiver field and deleting personal information of the exhibitor from the requester field, and the form affixed on the item is replaced with the new form.

FIG. 5B is an example of the delivery form prepared at the delivery service base 134. Information such as the address, name, phone number and the like of the successful bidder 150 notified from the auction company is entered in the “Receiver” field. Further, the user ID of the successful bidder 150 may also be entered. By entering the user ID, confirmation can be requested if the exhibitor 140 should enter a wrong auction ID or the like.

In the “Requestor” field, for example, the zip code of the service base (the delivery service base 134) in charge of collection/delivery from/to the address of the successful bidder is entered. The zip code of the delivery service base need not necessarily be entered. Further, similarly to FIG. 5A, the user ID of the exhibitor 140 may be entered.

Entries of the auction ID and the auction name or auction company (here, “□□ auction”) are the same as those in FIG. 5A. Such information is no longer needed to deliver the item to the successful bidder 150, but if such information is described, the successful bidder 150 can recognize that the content of the package is an item of “the auction ID 6754343 of □□ auction” by reading the delivery form and receive the item with a sense of security. The delivery form may also be such that the auction name or auction company and even the auction ID are not described therein.

Thus, by replacing the delivery form in FIG. 5A with that in FIG. 5B at the delivery service base 134, as described above, the item can be delivered from the delivery service base 134 to the successful bidder 150 without personal information of the exhibitor 140 being entered in the delivery form (without letting the successful bidder 150 know personal information of the exhibitor 140).

(5) Item Delivery

The item is delivered from the delivery service base 134 to the address of the successful bidder 150 according to a conventional delivery method of the delivery company 130.

Thus, according to a delivery management system of the present embodiment, as described above, an auction company notifies an exhibitor only of information about a delivery service base (which is a service base in charge of collection/delivery from/to the address of a successful bidder and includes transit service bases) for delivery of an auction (transaction) item. On the other hand, the exhibitor notifies the auction company of the form number of a delivery form affixed to the item.

The exhibitor enters delivery service base information in the receiver field of the delivery form and carries in the item to an acceptance service base (a service base to which the exhibitor carries in an item). Accordingly, the item can be sent to the delivery service base even if the exhibitor does not know personal information such as the address, name and the like of the successful bidder. A delivery form in which the form number and necessary information are described may be prepared by the auction company and sent to the exhibitor. Automatic generation of a delivery form will be described in detail later.

On the other hand, the delivery service base at which the item arrives, on the other hand, makes an inquiry by informing the auction company of the form number of the delivery form. In response to the inquiry, the auction company notifies the delivery service base of information necessary for delivery to the successful bidder. At the delivery service base, a new form is prepared by entering information necessary for delivery to the successful bidder in the receiver field and deleting information of the exhibitor that is not necessary for delivery from the requester field, and the form affixed to the item is replaced with the new form. Accordingly, the item can be delivered from the delivery service base to the successful bidder even without personal information of the exhibitor being entered in the delivery form (without the successful bidder being informed of personal information of the exhibitor).

Therefore, the successful bidder can receive the item without letting the exhibitor know personal information such as his (her) address, name and the like and the exhibitor can deliver the item without personal information of the exhibitor being known to the successful bidder. That is, according to a delivery management system of the present embodiment, items can be distributed while maintaining anonymity between exhibitors (vendors) and successful bidders (purchasers).

In addition, since transactions can be conducted without knowing personal information of other users, a burden of personal information protection of other users imposed on users in net auctions can be reduced.

A system in which the auction company also notifies the exhibitor of an auction ID (transaction ID) to make the exhibitor enter the auction ID in a form and the delivery service base makes an inquiry about personal information of the successful bidder by informing the auction company of the auction ID may also be adopted. An inquiry based on the auction ID will also be described in detail later.

<System Configuration Example of the Escrow Service Using a Delivery Management System of the Present Embodiment>

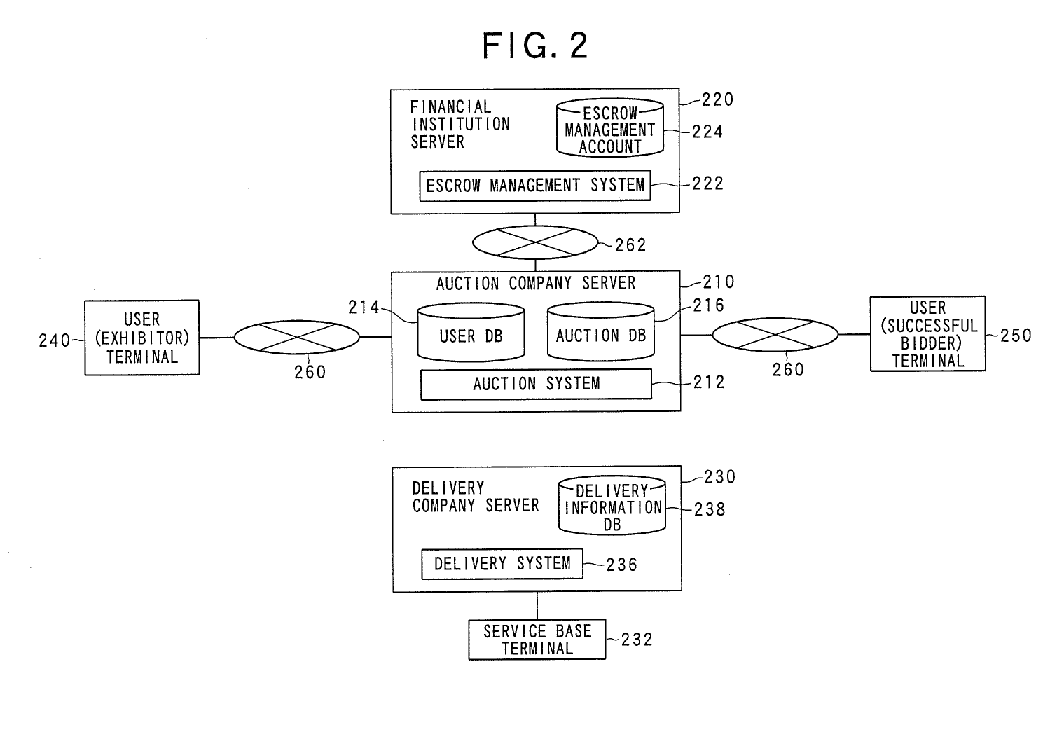

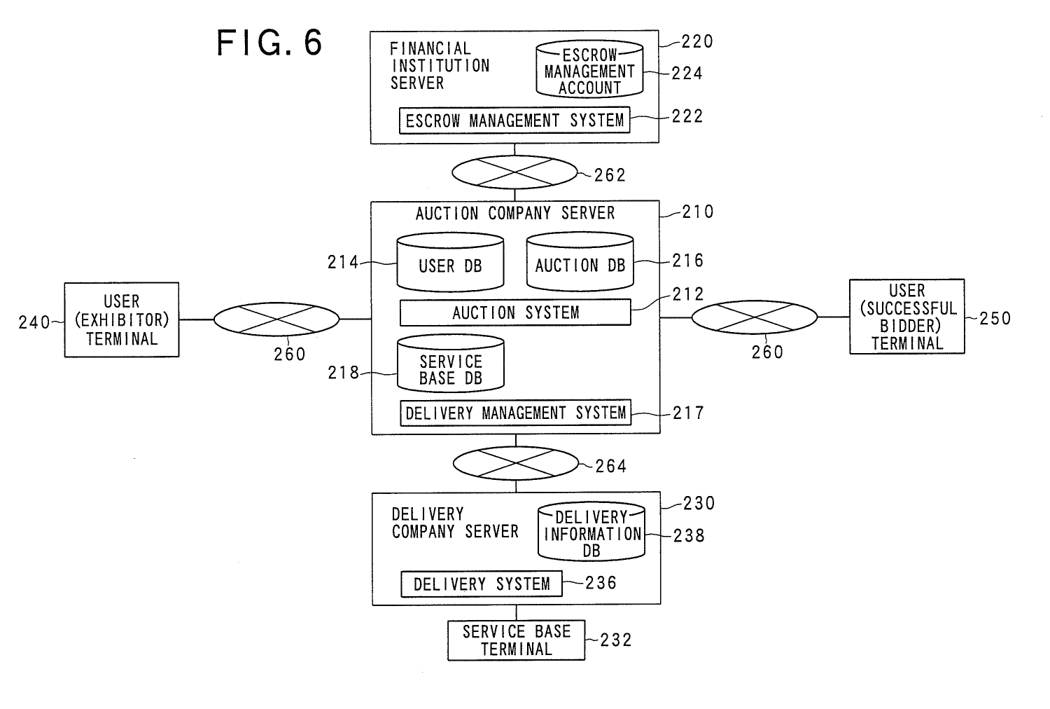

FIG. 6 shows an example of the system configuration for an example in which the escrow system using a delivery management system of the present embodiment described with reference to FIG. 4 is used for a net auction. Reference numerals in FIG. 6 correspond to those in FIG. 2.

In FIG. 6, the financial institution server 220, the delivery company server 230, the user (exhibitor) terminal 240, the user (successful bidder) terminal 250, and the communication networks 260 and 262 are the same as those in FIG. 2. A communication network 264 is a communication network connecting the service base terminal 232 and the delivery company server 230.

The service base terminal 232 is also similar to that shown in FIG. 2, but is different from the conventional example shown in FIG. 2 in that the terminal performs communication by logging in to the auction company server 210 via the communication network 264. Here, it is assumed that the service base terminal 232 is connected to the auction company server 210 via the delivery company server 230 and the communication network 264.

The auction company server 210 is, similarly to that shown in FIG. 2, is a server of the auction company 110, but is additionally provided with a delivery management system 217 and a service base database 218.

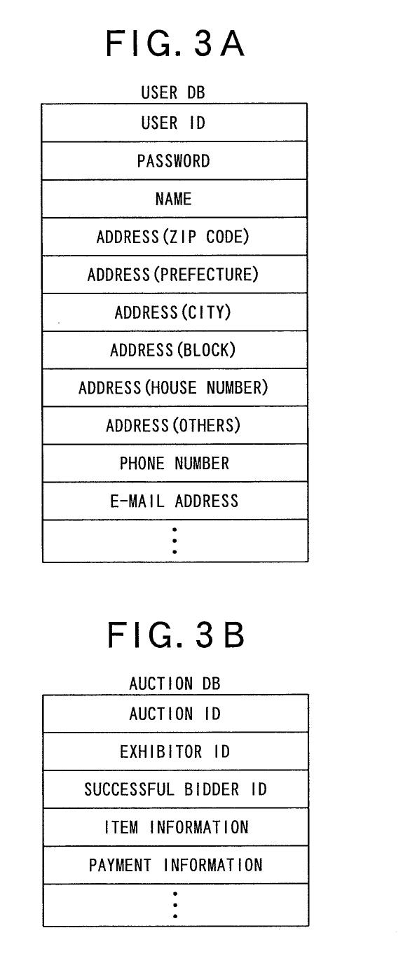

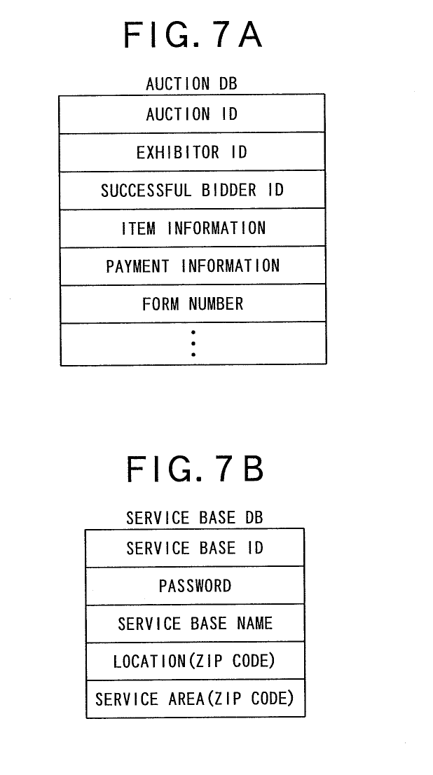

The delivery management system 217 stores, as described with reference to FIG. 4, the form number notified ((0-2) in FIG. 4) from the exhibitor terminal 240 via the Internet 260 in the auction database 216. Therefore, in the auction database 216 of the present embodiment, as shown in FIG. 7A, an item “Form number” is added as compared to the auction database (FIG. 3B) of conventional technology shown in FIG. 3B. Other items are the same as those of the auction database of conventional technology shown in FIG. 3B. Accordingly, the form number and information such as the auction ID are associated.

The delivery management system 217 also searches for a delivery service base corresponding to the successful bidder 150 and transmits delivery service base information to the exhibitor terminal 240 (0-3). In addition, the delivery management system 217 receives an inquiry (4-2) from the service base terminal 232 and searches for corresponding successful bidder information and transmits (4-3) the corresponding successful bidder information.

Each processing of the delivery management system 217 will be described in detail later.

The service base database 218 is a database in which service bases are registered so that the service base terminal 232 of the delivery company 130 can use the delivery management system 217 by logging in to the auction company server 210.

FIG. 7B shows main items of the service base database 218. “Service base ID” is an ID unique to each service base.

“Password” is a password of a service base and service bases registered in the service base database 218 uses, for example, the service base ID and the password to log in to the delivery management system 217 for an inquiry ((4-2) in FIG. 4). An inquiry is made, for example, by entering the form number described on the delivery form (the delivery form in FIG. 5(a)) in a Web page transmitted from the delivery management system 217 of the auction company server 210 after login and displayed on a display of the service base terminal 232, and transmitting the entered form number to the auction company server 210. “Service base name” is the name of the service base.

While “Service base ID” and “Password” are used for login in the present embodiment, an ID and a password may be distributed to each staff member stationed at each service base. In that case, the ID of each service base and that of each staff member are associated so that the service base can be identified by the ID of each staff member.

“Location (Zip code)” is a location of the service base. In the present embodiment, since delivery service base information to be notified to the exhibitor 140 is the zip code of the service base, at least the zip code of the service base should be stored in this item.

“Collection/delivery service area (zip code)” is an area taken charge of by the service base. In the present embodiment, it is assumed that the collection/delivery service area is stored as a zip code. That is, in the present embodiment, the service base whose collection/delivery service area includes the zip code of the address of a successful bidder can be determined to be the delivery service base. This is effective for the delivery company 130 (for example, Japan Post as described above) that supports division of the collection/delivery service area of each service base according to zip codes. For a delivery company that does not divide up the collection/delivery service area according to zip codes or does not support such division, the collection/delivery service area may be stored as a part of the address (for example, “House number □, XX-Cho, ΔΔ City, OO Prefecture”) or the like instead of the zip code so that a service base including the address of a successful bidder in the collection/delivery service area can be selected as the delivery service area, similarly to the case of zip codes described above. In the present embodiment, while the zip code is used as a key to identify the service base and the like, the present invention is not limited to this and code consisting of other numbers or alphabetical characters may also be used as a key.

In the present embodiment, an inquiry ((4-2) in FIG. 4) is made at the delivery management system 217 by using “Service base ID” and “Password”, but “Service base ID” and “Password” need not necessarily be used if a method which can perform authentication correctly between the delivery management system 217 and the service base terminal 232 is used.

Methods by which the delivery management system 217 can correctly identify the delivery service base include, for example, a method that uses the MAC address, global IP address or the like of the delivery service base for identification and biometric authentication that uses fingerprinting or voice for identification.

<Flow of Processing of the Escrow System Using a Delivery Management System of the Present Embodiment>

The delivery management system 217 of the present embodiment performs, as described above, each processing in (1) to (3) described below.

(1) Form Number Registration Processing

The form number received from the exhibitor terminal 240 is registered in association with an auction (transaction).

(2) Delivery Service Base Information Notification

The delivery service base in charge of the address of a successful bidder is selected and delivery service base information is transmitted to the exhibitor terminal 240.

(3) Successful Bidder Information Notification

In response to an inquiry from the delivery service base, successful bidder information is transmitted to the service base terminal 232 of the delivery service base.

Hereinafter, each processing of (1) to (3) will be described in detail. Here, as described above, an example in which an exhibitor is notified of the zip code of the delivery service base as delivery service base information and the collection/delivery service area of the service base database 218 is stored as the zip code is taken for description.

(1) Form Number Registration Processing

In the present embodiment, as described above, the URL of the Web page in which an exhibitor enters the form number of a delivery form of an item or obtains information about the delivery service base (which is a service base in charge of collection/delivery from/to the address of a successful bidder and includes transit service bases) is also notified when the end of an auction is notified ((0-1) in FIG. 4).

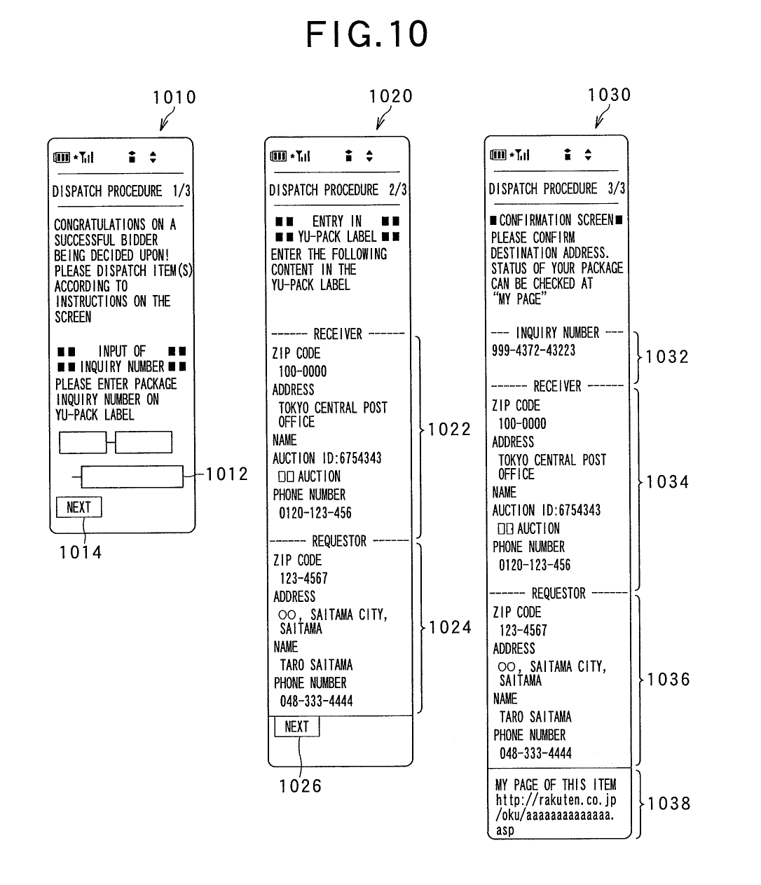

FIG. 10A is an example of a form number input page displayed on the exhibitor terminal 240 and used by an exhibitor to enter the form number. While an example of the Web page when the exhibitor terminal 240 is a mobile phone is shown here, content to be displayed in the Web page is the same when the exhibitor terminal 240 is a personal computer.

On the form number input page 1010, the form number described in advance on the delivery form prepared by the exhibitor to send an item is entered in a form number input field 1012.

When the form number is entered and a “Next” button 1014 is clicked, the form number is transmitted to the auction company server 210 and the received form number is stored in the auction database 216 by form number registration processing.

Immediately thereafter, delivery service base information notification processing is performed to transmit a delivery service base information viewing page shown in FIG. 10B to the exhibitor terminal 240. The order of the form number registration processing and delivery service base information notification processing is not limited to this and either of the two may be performed first, as described above, but by performing the form number registration processing first, the auction company server 210 can reliably register the form number.

(2) Delivery Service Base Information Notification Processing

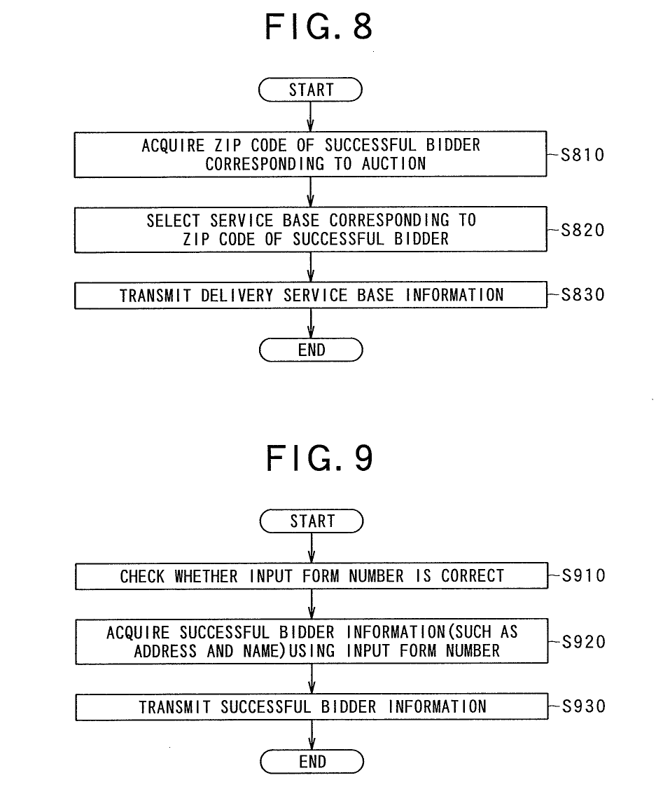

FIG. 8 is a flow chart showing the flow of delivery service base information notification processing performed by the delivery management system 217 of the present embodiment.

First, the zip code of the exhibitor of the auction is acquired (S810). More specifically, the zip code of the user is acquired by referencing the user database 214 in FIG. 3A using the successful bidder user ID of the auction database shown in FIG. 7A as a key.

Next, service base information corresponding to the zip code of the successful bidder is acquired (S820). More specifically, the service base database 218 is referenced using the acquired zip code of the successful bidder as a key to acquire a zip code of the service base that includes the zip code of the successful bidder as a collection/delivery service area as the service base information.

Finally, the successful bidder 150 is notified of the acquired delivery service base information (the zip code of the delivery service base and the prefecture of the delivery destination) (S830). The notification can be made, as described above, by transmission of an e-mail or a Web page that can be viewed only by the exhibitor.

FIG. 10B is an example of a delivery service base information viewing page displayed on the exhibitor terminal 240. On the delivery service base information viewing page 1020, a receiver display field 1022 displays items that the exhibitor should enter in the receiver field of the delivery form (FIG. 5A). For example, the zip code of the service base and the service base name are displayed. Also, the auction ID and auction name are displayed.

On the other hand, a requestor display field 1024 displays, on the other hand, personal information of the exhibitor as items that the exhibitor should enter in the requester field of the delivery form (FIG. 5A) by reading the personal information of the exhibitor from the user database 214.

When a “Next” button 1026 is clicked, the page moves to a confirmation page shown in FIG. 10C.

On the confirmation page 1030, the form number is displayed in a form number display field 1032. A receiver display field 1034 and a requester display field 1036 are the same as those in the delivery service base information viewing page 1020. When a link 1038 to an item page is clicked, the page moves to a Web page showing information about the item of the auction, progress of the auction and the like.

A successful bidder can also view the confirmation page 1030 at the successful bidder terminal 250. The confirmation page 1030 for the successful bidder is the same as that for the exhibitor in the form number display field 1032 and the link 1038 to an item page, but displays personal information of the successful bidder in the receiver display field 1034 and information about the service base in charge of collection/delivery from/to the address of the exhibitor in the requester display field 1036.

Thus, by displaying the form number also in the confirmation page 1030 that can be viewed by the successful bidder in this manner, the successful bidder can make an inquiry at the delivery company or use the package tracking service.

(3) Successful Bidder Information Notification Processing

FIG. 9 is a flow chart showing the flow of successful bidder information notification processing performed by the delivery management system 217 of the present embodiment.

It is assumed that the delivery management system 217 is normally logged in from the service base terminal 232 of the delivery service base 134, a form number is entered in an input display displayed on the service base terminal 232, and the form number is transmitted to the auction company server 210.

First, it is better to check whether the form number entered from the service base terminal 232 of the delivery service base 134 is correct (S910) More specifically, for example, a check whether the form number is entered from the correct service base terminal (the service base at which the item is to be received) (that is, whether the auction ID is entered from the delivery service base whose collection/delivery service area includes the address of the successful bidder notified in processing of step S830 in FIG. 8) or the like is made. When the check is performed, for example, it is better to notify the service base terminal of successful bidder information only if the service base that entered the auction ID and the delivery service base selected in the delivery service base information notification processing match with each other. If the service bases do not match (due to a wrong delivery or the like), it is better, for example, to deliver the item to the correct delivery service base by notifying the service base terminal of the delivery service base information. Content to be checked is not limited to this and may freely be decided in accordance with the system.

If the input form number is determined to be incorrect as a result of the check, a display to indicate an error is transmitted to the service base terminal 232, or a notification is made to the service base by a method of retransmitting an input display with a blank input field to the service base terminal 232 or the like and the processing is terminated.

If the input form number is determined to be correct as a result of the check, successful bidder information (personal information such as the address and name of the successful bidder 150) is acquired using the input form number (S920). More specifically, the auction having the input form number is read from the auction database 216, and the address, name and the like of the successful bidder are acquired by referencing the user database 214 using the successful bidder user ID of the auction as a key.

Finally, the acquired successful bidder information (the address, name and the like of the successful bidder) is transmitted to the service base terminal 232 (S930). For example, the successful bidder information can be transmitted by displaying the information on a Web page.

In the foregoing, the delivery service base information is transmitted from the auction company server 210 to the exhibitor terminal 240 by the delivery service base information notification processing of the delivery management system 217, and the exhibitor makes entries in a delivery form shown in FIG. 5A according to content of the delivery service base information. Here, if the exhibitor terminal 240 is a personal computer, electronic data of a delivery form with items shown in FIG. 5A entered can automatically be generated and sent to the exhibitor terminal 240 by the auction company server 210. In such case, the exhibitor needs only to print the delivery form and affix the delivery form to an item.

Thus, the delivery management system 217 is further provided with form number generation processing. In the form number generation processing, for example, a form number unique to each auction (transaction) is generated when the auction ends. The form number is generated according to a rule for the form number used by the delivery company. Alternatively, the form number may be obtained from the delivery company in advance. In the form number registration processing, the form number generated here is stored in the auction database 216.

Then, in the delivery service base information notification processing, after selecting the delivery service base, the form number and electronic data (for example, a PDF file) of the delivery form with the items (delivery service base information and the address, name and the like of the exhibitor) shown in FIG. 5A described thereon are generated and transmitted to the exhibitor terminal 240.

In the form number input page shown in FIG. 10A or the like, it is better to allow a selection between receiving an automatically generated delivery form and preparing and filling in a delivery form by an exhibitor (in this case, the form number is entered on a form number input page).

In the foregoing, the form number of the delivery form is stored in the auction database 216 and the service base terminal 232 makes an inquiry about successful bidder information at the auction company server 210 using the form number. Here, instead of the form number, the auction ID (transaction ID) may be used to make an inquiry. In this case, the form number registration processing need not be performed.

Thus, the delivery management system 217 is further provided with transaction ID notification processing. While the auction ID can be notified by an e-mail or the like when an auction starts, it is better to also make a notification of the auction ID when the auction ends for convenience of the exhibitor (for example, the notification may be included in an auction end notification ((0-1) in FIG. 4)). Alternatively, the auction ID may be displayed on a Web page that can be viewed only by an exhibitor.

Then, the auction ID is entered also in the delivery form (FIG. 5A). The delivery service base can make an inquiry about information needed for delivery to the successful bidder by informing the auction ID to the auction company.

The above is an embodiment where a delivery management system of the present invention is used for an escrow system, but the delivery management system is not limited to being used for an escrow system. Hereinafter, an embodiment where the delivery management system of the present invention is used for delivery by other than the escrow system will be described with reference to the drawings.

<Overview of a Delivery System Using a Delivery Management System of the Present Embodiment>

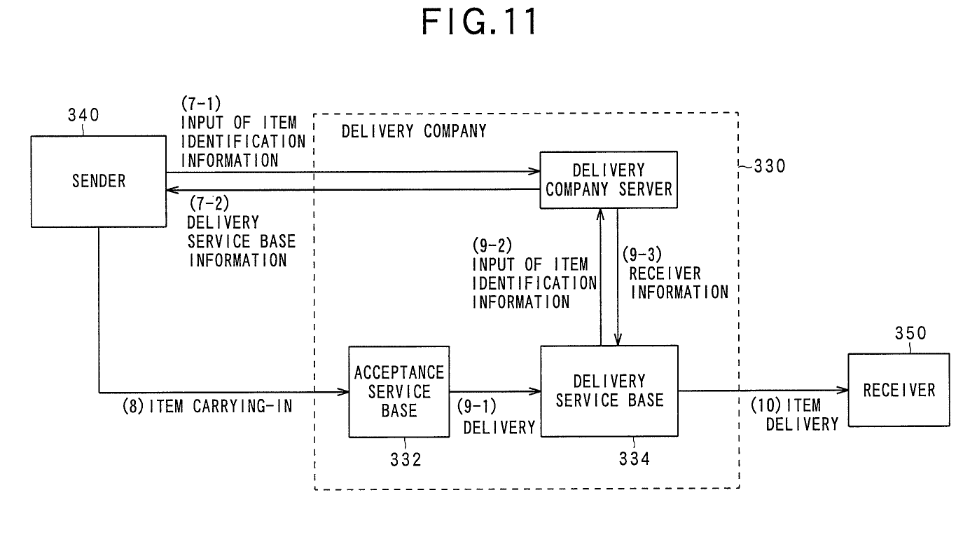

FIG. 11 shows an example of the flow of items when a delivery management system of the present embodiment is used for normal delivery. Here, only processing related to delivery of items will be described. For a process up to a conclusion of an item transaction contract, a conventional auction system may be used or any other method that links information about delivery of items between a sender and a receiver may be used.

A sender 340 and a receiver 350 are a person who sends an item that is delivered by using a delivery management system and a person who receives such an item, respectively. A delivery company 330 accepts an item that a sender carries in to an acceptance service base 332 and delivers the item to the receiver 350 via a delivery service base 334.

Before carrying in the item to the acceptance service base 332, the sender 340 makes an inquiry about information on the delivery service base of the delivery company by using identification information of the item ((7-1) in FIG. 11). The identification information of the item used here may be obtained by any method for linking information about a sender and a receiver such as a conventional auction system. The delivery company 330 accepts entries, searches for information about the receiver, searches further for information about the delivery service base based on the information about the receiver, and transmits the information about the delivery service base ((7-2) in FIG. 11).

The sender enters information about the delivery service base and an identification number of the item in the receiver field of a delivery form and carries in the item to the delivery service base ((8) in FIG. 11). Personal information of the exhibitor may be entered in the requester field. Accordingly, the item can be delivered up to the delivery service base even if the sender does not know personal information such as the address and name of the receiver ((9-1) in FIG. 11). A delivery form with the form number and necessary information entered may be prepared by the delivery company and sent to the exhibitor. Information (FIG. 5A) similar to that in the embodiment used for the escrow system may be entered in the delivery form.

At the delivery service base where the item arrives, receiver information is searched for based on the identification number of the item ((9-2) in FIG. 11), information necessary for delivery to the receiver is acquired ((9-3) in FIG. 11), a new form in which the acquired information is entered in the receiver field and information about the sender unnecessary for delivery is deleted from the requester field is prepared, and the form affixed to the item is replaced with the new one. Information (FIG. 5B) similar to that in the case used for the escrow system may be entered in the delivery form. Accordingly, the item can be delivered from the delivery service base to the receiver even if personal information of the sender is not described in the delivery form (even if the receiver is not informed of personal information of the sender) ((10) in FIG. 11). Also, the transmission of the information necessary for delivery to the receiver can be recorded. Accordingly, it is possible to determine that the item has entered a delivery process to the receiver ((10) in FIG. 11). If the item erroneously arrives at a delivery service base where the item should not arrive, an instruction to transfer the item to the correct delivery service base can be issued.

Accordingly, the receiver 350 can receive the item without letting the sender 340 know personal information such as his (her) address, name and the like and the sender 340 can deliver the item without personal information of the sender being known to the receiver 350. That is, according to the present invention, items can be distributed while maintaining anonymity between senders and receivers.

<Configuration Example of a Delivery System Using a Delivery Management System of the Present Embodiment>

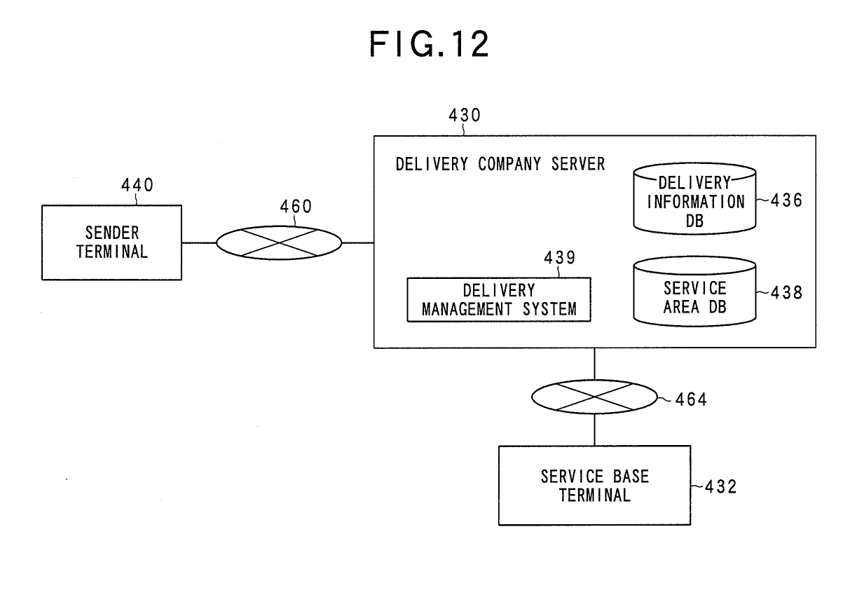

FIG. 12 shows an example of the system configuration of a delivery system using a delivery management system of the present embodiment described with reference to FIG. 11.

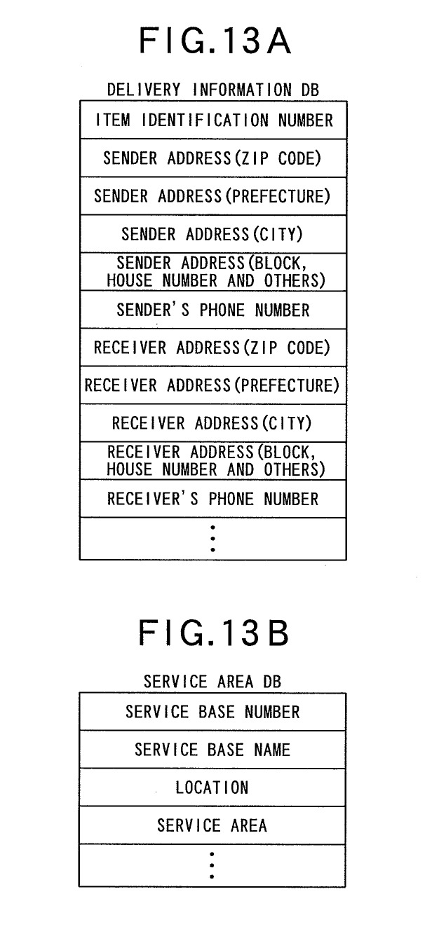

In FIG. 12, a delivery company server 430 is a computer used by a delivery company to deliver an item accepted from a sender to a receiver. The delivery company server 430 has a delivery information database 436 in which information for identifying each of the sender and receiver and item identification information for identifying an item delivered between both are stored in association with each other. FIG. 13A is an example of information stored in the delivery information database 436. The information for identifying each of the sender and receiver and the item identification information for identifying an item delivered between both may be provided in advance by, for example, a conventional auction system, and the information obtained by a method of linking information about a sender and a receiver may be any information.

The delivery company server 430 also has a service area database 438 in which location information of delivery service bases is stored so that the service base in charge of delivery to the delivery destination of an item can be identified. FIG. 13B is an example of information stored in the service area database 438.

The delivery company server 430 is connected to a sender terminal 440 through a communication network 460 such as the Internet. The delivery company server 430 is also connected to a delivery service base terminal 432 through a communication network 464 such as an intranet.

<Flow of Processing of a Delivery System Using a Delivery Management System of the Present Embodiment>

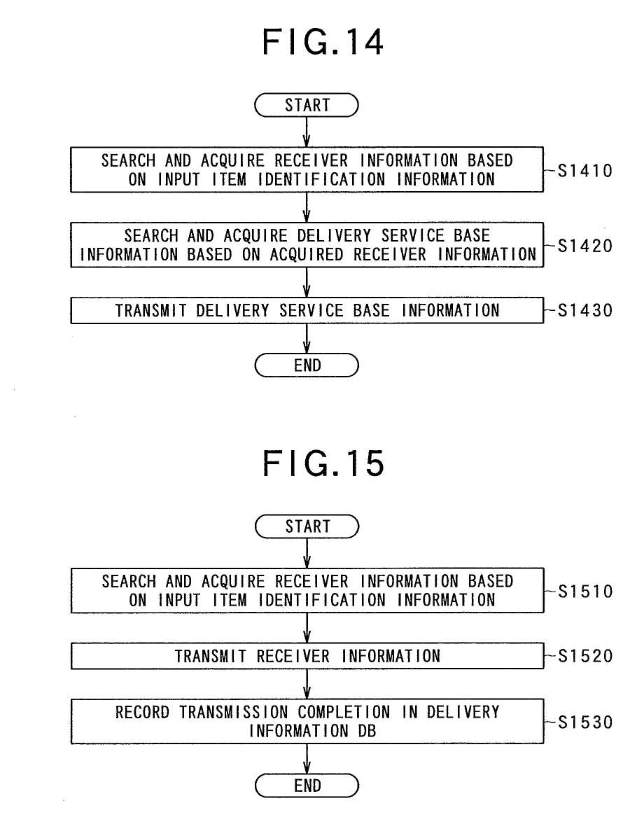

The delivery company server 430 in the present embodiment performs each of the following processings. FIG. 14 to FIG. 16 are flow charts each showing the flow of processing of the delivery company server 430.

(1) Service Base Information Notification

When item identification information is input from the sender terminal 440 via the communication network 460 in FIG. 12, the delivery information database 436 is searched to acquire information necessary for delivery to the receiver (S1410 in FIG. 14) and next, the service area database 438 is searched based on this information to acquire information about the delivery service base in charge of delivery to the receiver (S1420 in FIG. 14). Then, delivery service base information is transmitted to the sender terminal 440 via the communication network 460 (S1430 in FIG. 14).

(2) Receiver Information Notification

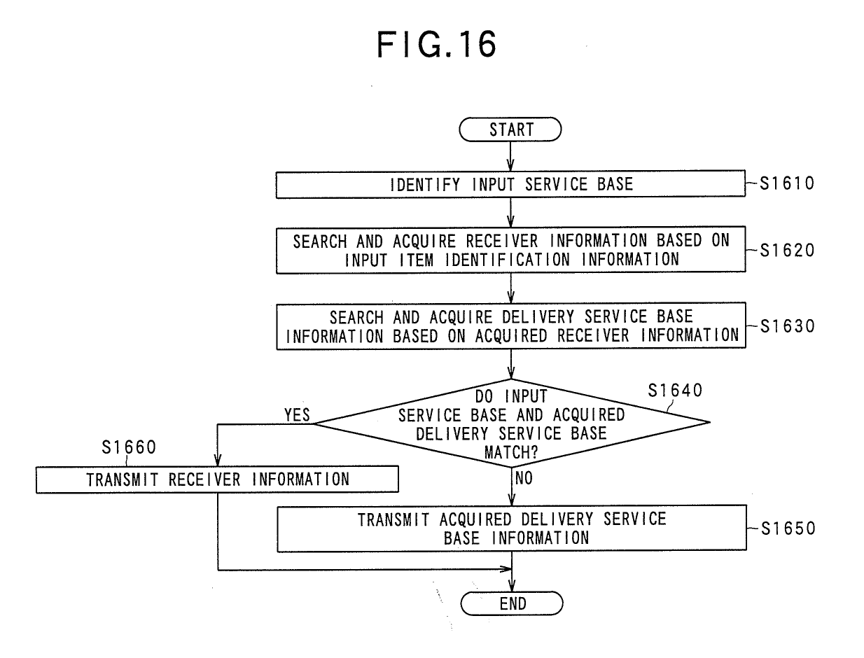

When item identification information is input from the delivery service base terminal 432 via the communication network 464 in FIG. 12, the delivery information database 436 is searched to acquire information necessary for delivery to the receiver (S1510 in FIG. 15) and the information is transmitted to the delivery service base terminal 432 (S1520 in FIG. 15). This results in a state of being able to deliver the item to the receiver and herein after, the delivery company delivers the item to the receiver by a normal method.

(3) Delivery Completion Confirmation

When information necessary for delivery to the receiver is transmitted to the delivery service base terminal 432 in (2), the delivery company server 430 records the completion of transmission of information necessary for delivery to the receiver according to the item identification number in the delivery information database 436 (S1530 in FIG. 15). Accordingly, it can be determined that the item sent by the sender has reached the delivery service base, that the information necessary for delivery to the receiver has been transmitted and that the process entered the delivery process to the receiver.

(4) Delivery Service Base Identification

It is assumed in FIG. 12 that the item is erroneously delivered to a wrong delivery service base not in charge of delivery to the receiver due to, for example, an erroneous entry in the delivery form by the sender. When the input in (2) is performed from the delivery service base terminal 432 to the delivery company server 430, the service base where the delivery service base terminal 432 is located is identified (S1610 in FIG. 16), the delivery information database 436 is searched based on the input item identification information to acquire information necessary for delivery to the receiver (S1620 in FIG. 16), and next, the service area database 438 is searched based on this information to acquire information about the delivery service base in charge of delivery to the receiver (S1630 in FIG. 16). This information and the service base where the delivery service base terminal 432 used to input the item identification information is located are compared (S1640 in FIG. 16). If the information and the service base are different (No at S1640 in FIG. 16), information about the delivery service base in charge of delivery to the receiver is transmitted to the delivery service base terminal 432 (S1650 in FIG. 16). The delivery service base that received the information delivers the item to the correct delivery service base following the information displayed on the delivery service base terminal 432. If, on the other hand, the delivery service base information acquired from the service area database 438 and the service base where the item identification information was input match (Yes at S1640 in FIG. 16), information about the receiver is transmitted to the delivery service base terminal 432 (S1660 in FIG. 16). That is, when the item is erroneously delivered to a wrong delivery service base not in charge of delivery to the receiver, information about the delivery service base in charge of delivery, instead of information about the receiver, is transmitted and thus, the item can reliably be delivered.

Methods by which the delivery company server 430 can identify the delivery service base where information was input include, for example, a method that uses the MAC address, global IP address or the like of the delivery service base for identification and biometric authentication that uses fingerprinting or voice for identification.

1. A delivery management system for delivering an auction item from an auction exhibitor to a successful auction bidder via an acceptance service base and a delivery service base using a delivery form on which identification information is described, comprising:
a server connected to a terminal of the auction exhibitor and a terminal of the delivery service base which delivers the auction item,
the server comprising:
user storage means for storing address and name information of the auction exhibitor and the successful auction bidder;
transaction storage means for storing the auction exhibitor and the successful auction bidder in association with each other based on each auction ID of the auction item;
service base storage means for storing location information of the delivery service base and delivery service area information taken charge of by the delivery service base in association with each other;
identification information registration means for, when identification information described on the delivery form of the auction item is input from the terminal of the auction exhibitor after a successful bid of the auction item, storing the identification information in the transaction storage means in association with the auction ID;
delivery service base information notification means for searching for the delivery service base whose delivery service area includes the address of the successful auction bidder stored in the user storage means after the successful bid of the auction item, and transmitting the location information of the delivery service base to the terminal of the auction exhibitor; and
successful auction bidder information notification means for, when an inquiry based on the identification information is received from the terminal of the delivery service base at the delivery service base to which the auction item is delivered from the acceptance service base, searching the identification information registration means for the auction ID associated with the identification information, searching the transaction storage means for the successful auction bidder associated with the auction ID, and transmitting the address and name of the successful auction bidder to the terminal of the delivery service base.

2. The delivery management system according to claim 1,
wherein the location information stored in the service base storage means includes a zip code, and
the delivery service base information notification means transmits the zip code of the searched service base to the terminal of the auction exhibitor.

3. The delivery management system according to claim 1,
wherein the address information stored in the user storage means includes the zip code,
the service base storage means stores the delivery service area information as the zip code, and
the delivery service base information notification means searches for the delivery service base of the delivery service area corresponding to the zip code of the successful auction bidder.

4. The delivery management system according to claim 1, further comprising:
identification information generation means for generating identification information corresponding to each transaction,
wherein the identification information registration means stores the generated identification information in the service base storage means in association with the auction ID, and
the delivery service base information notification means generates electronic data of the delivery form having the identification information and the location information of the searched service base and transmits the electronic data to the terminal of the auction exhibitor.

5. The delivery management system according to claim 1,
wherein the delivery service base information notification means transmits the auction ID to the terminal of the auction exhibitor together with the location information of the delivery service base or instead of the location information of the delivery service base.

6. The delivery management system according to claim 1,
wherein when the identification information or auction ID transmitted from the terminal of the delivery service base at the delivery service base to which the auction item with the delivery form attached thereto is delivered is received, the successful auction bidder information notification means transmits the address and name of the associated successful auction bidder from the user storage means to the terminal of the delivery service base.

7. The delivery management system according to claim 1,
wherein the service base storage means further stores a service base ID of the delivery service base, and
when the identification information or auction ID is received from the terminal of the service base, the successful auction bidder information notification means searches the service base storage means for the transmitted service base ID of the service base, and
if the service base ID and that the service base ID identifying the service base searched by the delivery service base information notification means match each other, the successful auction bidder information notification means transmits delivery service base information to the terminal of the service base, and

8. A delivery management system for delivering an item from a sender to a receiver, comprising:
a server connected to a terminal of the sender and a terminal of each service base which collects/delivers the item,
the server comprising:
delivery information storage means for storing information identifying each of the sender and the receiver and item identification information identifying the item in association with each other;
service area storage means for storing location information of the service base so that the service base in charge of collection/delivery from/to a collection/delivery destination of the item can be identified;
service base information notification means for, when the item identification information is input from the terminal of the sender, searching the delivery information storage means for information about the receiver associated with the item identification information, further searching the service area storage means for information about the delivery service base in charge of delivery to the receiver, and transmitting the information about the service base to the terminal of the sender; and
receiver information notification means for, when the identification information about the item delivered based on the service base information obtained by the service base information notification means as a destination is input from the terminal of the delivery service base, searching the delivery information storage means for receiver information of the item, and transmitting the receiver information to the terminal of the service base.

9. The delivery management system according to claim 8, further comprising:
delivery completion confirmation means for checking at the service base whether or not delivery is completed by setting the receiver information obtained by the receiver information notification means as a new delivery destination of the item.

10. The delivery management system according to claim 8,
wherein the receiver information notification means identifies from which service base input from the terminal of the service base comes and searches the service area storage means for the delivery service base to take charge of delivery when the receiver is set as a delivery destination,
if the two service bases match each other, the receiver information notification means transmits the receiver information searched from the delivery information storage means to the terminal of the service base, and
if the two service bases do not match each other the receiver information notification means searches the service area storage means for information about the delivery service area, and transmits, instead of the receiver information, the information about the delivery service area to the terminal of the service base.

11. The delivery management system according to claim 8,
wherein the information to identify the sender and the receiver includes at least a name and an address,
the item identification information includes at least one of a form number related to delivery of the item and a transaction ID related to a transaction of the item, and
the information related to the service base includes at least one of a name, a location, or a zip code of the service base.

12. A delivery management method for delivering an item from a vendor to a purchaser,
wherein address and name information of the vendor and the purchaser is stored in user storage means,
the vendor and the purchaser are stored in transaction storage means in association with each other based on each transaction ID of transaction of the item, and
location information of the service base and collection/delivery service area information taken charge of by the service base are stored in service base storage means in association with each other,
the method comprising:
a form number registration step of, when a form number of the item is input from the terminal of the vendor, storing the form number in the transaction storage means in association with the transaction ID;
a delivery service base information notification step of searching for the delivery service base whose collection/delivery service area includes the address of the purchaser stored by the user storage means, and transmitting the location information of the delivery service base to the terminal of the vendor; and
a purchaser information notification step of, when an inquiry based on the form number is received from the terminal of the delivery service base, searching the form number registration means for the transaction ID associated with the form number, searching the transaction storage means for the purchaser associated with the transaction ID, and transmitting the address and name of the purchaser to the terminal of the delivery service base.

13. A delivery management method for delivering an item from a sender to a receiver,
wherein information identifying each of the sender and the receiver and item identification information identifying the item are stored in delivery information storage means in association with each other, and
location information of the service base is stored in service area storage means so that the service base in charge of collection/delivery from/to a collection/delivery destination of the item can be identified,
the method comprising:
a service base information notification step of, when the item identification information is input from the terminal of the sender, searching the delivery information storage means for information about the receiver associated with the item identification information, further searching the service area storage means for information about the delivery service base in charge of collection/delivery from/to the receiver, and transmitting the information about the delivery service base to the terminal of the sender; and
a receiver information notification step of, when the identification information about the item delivered based on delivery service base information obtained at the service base information notification step as a destination is input from the terminal of the delivery service base, searching the delivery information storage means for the receiver information of the item, and transmitting the receiver information of to the terminal of the delivery service base.

14. A recording medium having a program computer-readably recorded therein, the program causing a computer to realize each means of the delivery management system according to claim 1 as a function.

15. (canceled)
